(19) United States
(12) Patent Application Publication
(10) Pub. No.: US 2017/0315615 A1
(43) Pub. Date: Nov. 2, 2017

(54) GESTURE LIBRARY

(71) Applicant: HEWLETT-PACKARD DEVELOPMENT COMPANY, L.P., HOUSTON, TX (US)

(72) Inventors: GREGORY WILLIAM COOK, PALO ALTO, CA (US); JISHANG WEI, PALO ALTO, CA (US); MITHRA VANKIPURAM, PALO ALTO, CA (US); CHIH PIN HSIAO, PALO ALTO, CA (US)

(21) Appl. No.: 15/518,531

(22) PCT Filed: Dec. 19, 2014
(86) PCT No.: PCT/US2014/071607

§ 371 Date: Apr. 12, 2017

(51) Int. Cl. G06F 3/01; G06F 3/03

(52) U.S. Cl. CPC G06F 3/014; G06F 3/017; G06F 3/0304

(57) ABSTRACT

An example method is provided in according with one implementation of the present disclosure. The method includes analyzing data related to at least one detected hand, performing a hand posture analysis to identify a hand posture of the at least one hand and a key point of the at least one hand for the identified hand posture, and performing a hand motion analysis to identify a hand motion by the at least one hand based on the hand posture and the key point. The hand posture is selected from a predefined group of hand postures and the hand motion is selected from a predefined group of hand motions. The method further includes selecting a gesture from a gesture library based on a combination of the hand posture and the hand motion of the at least one hand.

### BACKGROUND

Interactive devices and systems that allow users to interact with different digital content continue to play an important role today. Some of these devices and systems may display three-dimensional (“3D”) virtual objects (also called 3D visualizations). Organizations and individuals regularly use different types of interactive devices and systems in various areas and for different applications.

### BRIEF DESCRIPTION OF THE DRAWINGS

FIG. 1 is a schematic illustration of an example interactive system in accordance with an implementation of the present disclosure.

FIG. 2 illustrates a flow chart showing an example of a method for selecting a gesture from a gesture library in accordance with an implementation of the present disclosure.

FIG. 3 illustrates a flow chart showing an example of a method for identifying a hand posture in accordance with an example implementation of the present disclosure.

FIGS. 4A-4E illustrate an example of a predefined group of hand postures in accordance with an example implementation of the present disclosure.

FIGS. 5A-5F illustrate an example of a predefined group of hand motions in accordance with an example implementation of the present disclosure.

FIG. 6 illustrates an example of a gesture library showing possible hand posture and hand motion combinations in accordance with an example implementation of the present disclosure.

FIG. 7 is an example block diagram illustrating a computer-readable medium in accordance with an implementation of the present disclosure.

### DETAILED DESCRIPTION OF SPECIFIC EXAMPLES

As noted above, with the recent improvements in technology, interactive devices and systems (i.e., devices and systems that may display digital content and allow for user interaction) are becoming increasingly popular in all industries. As used herein, the term “digital content” refers to any type of content that exists in the form of digital data. Interactive devices and systems come in different sizes, forms, and may include different technical features. Different users rely on different type of interactive devices or systems for many day-to-day activities and work related tasks. As used herein, the term “user” refers to any type of individual, organization, group, business, or any other party that may need to operate or communicate with an interactive device or a system.

Due to the proliferation of various electronic devices, the technological capabilities of interactive systems are continuously changing and increasing. These devices and systems may be capable of displaying different types of digital content such as 3D visualizations (also called virtual objects), etc. As used herein, the terms “3D visualization” and “virtual object” are to be used interchangeably and refer to any type of 3D image or 3D formation that may be displayed and viewed. As a result, these interactive devices and systems may be widely used by organization, businesses, or individual users.

One problem with the available interaction devices and systems is that they may not offer accurate and efficient ways for users to identify different gestures used to interact with these devices and systems. As used herein, the term “gesture” refers to a composition of a hand posture and a hand motion which a user of interaction system or device may perform. In other words, these hand posture and hand motion combinations may be gestures for manipulating virtual objects in digital environment, such as applications for virtual reality, augmented reality, immersive environment, etc. In some situations, the existing techniques for identifying user gestures and manipulating digital content are too complex and cumbersome.

Due to the encumbrances described above, the learning curve of operating such systems and manipulating digital content may be significantly extended, which makes these systems less desirable for users. Therefore, improved techniques and a gesture library that may assist with creating, navigating, manipulating, modifying, etc. digital content are desired.

The present description is directed to an improved solution for selecting a gesture from a gesture library based on a combination of a hand posture and a hand motion. In one example, a processor may analyze data related to at least one detected hand of a user and may perform a hand posture analysis to identify a hand posture of the at least one hand and a key point of the at least one hand for the identified hand posture, where the hand posture is selected from a predefined group of hand postures. As used herein, the term “key point” refers to a point of a hand when the hand is at a specific posture, where that key point is used to optimize the results of a hand motion analysis. The processor may further perform a hand motion analysis to identify a hand motion by the at least one hand based on the hand posture and the key point, and may select a gesture from a gesture library based on a combination of the hand posture and the hand motion of the at least one hand. The hand motion may be selected from a predefined group of hand motions

The proposed library of hand gestures may incorporate natural motions that are easy to learn and manipulate when used to manipulate digital content (e.g., content rendered in 3D). The gesture library may adopt the natural way users interact with real world objects in daily life, instead of inventing new gesture languages for specific situations. The gesture library may be easily adapted for different use cases, including but not limited to the creation, navigation, manipulation, modification of digital content (e.g., 3D data visualizations). The proposed gesture recognition technique is low-complexity technique that is easy to implement for different applications.

Thus, the proposed techniques and gesture library help a user to easily interact with the digital environment in the an interaction system, reduce the learning curve needed to interact with the objects in digital world, and support broad interaction tasks needed when exploring digital environment. This will increase the effectiveness, efficiency and user satisfaction with interactive systems.

In the following detailed description, reference is made to the accompanying drawings, which form a part hereof, and in which is shown by way of illustration specific examples in which the disclosed subject matter may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. Also, it is to be understood that the phraseology and terminology used herein is for the purpose of description ad should not be regarded as limiting. The use of “including,” “comprising” or “having” and variations thereof herein is meant to encompass the items listed thereafter and equivalents thereof as well as additional items. Furthermore, the term “based on,” as used herein, means “based at least in part on.” It should also be noted that a plurality of hardware and software based devices, as well as a plurality of different structural components may be used to implement the disclosed methods and devices.

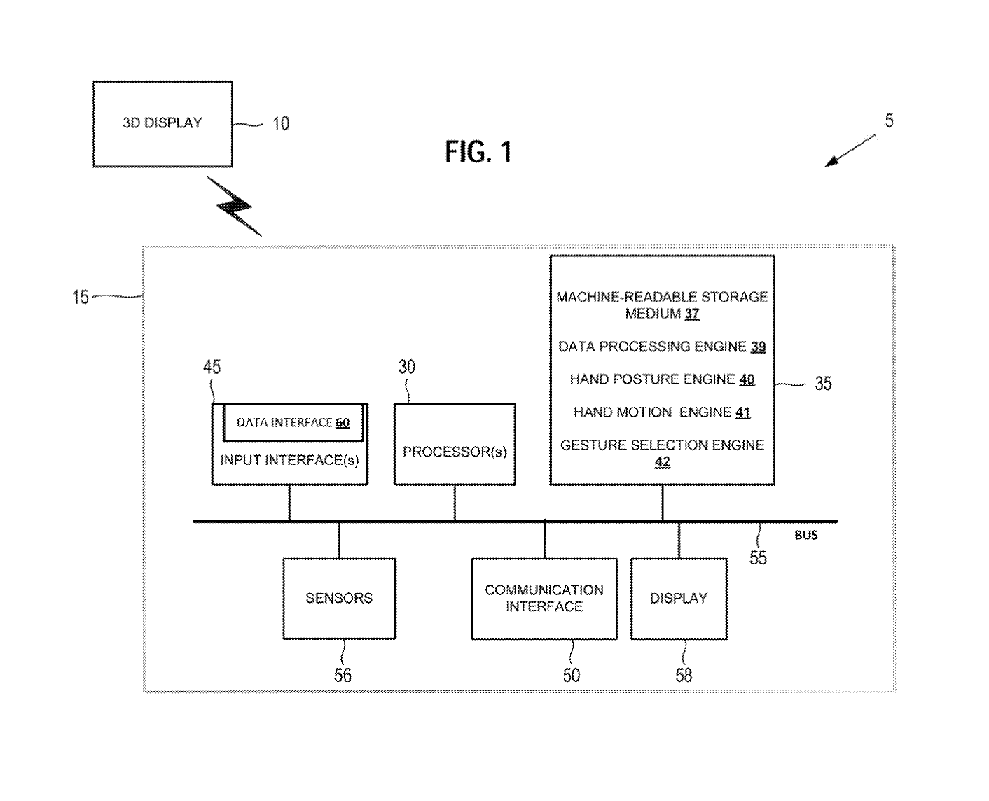

Referring now to the figures, FIG. 1 is a schematic illustration of an example interactive system 5. The illustrated system 5 is capable of carrying out the techniques described below. It is to be understood that the system 5 is only an example interactive system and the techniques described below may be carried by a different interactive system. As shown in FIG. 1, the system 5 is depicted as including a 3D display 10 (e.g., a stereoscopic display) and an auxiliary computing device 15.

The 3D display 10 may display digital content (e.g., at least one 3D visualization; not shown) that can include any type of 3D object (e.g., data, text, media, etc.). In one example, the 3D object may be shown on physical surface or screen (not shown) of the 3D display 10. In another example, the 3D object may appear floating in 3D space defined around (e.g., in front, in back, on top, on side, etc.) the 3D display 10 (not shown).

In one implementation, the computing device 15 may be a portable computing device (e.g., a tablet, a laptop, a smartphone, a personal digital assistant (PDA), etc.). In some examples, the system 5 may involve multiple users where each user “brings” a separate computing device for simultaneous or separate interaction with the 3D display 10.

The computing device 15 may include at least one processor 30, a memory 35, a plurality of engines 39-42, an input interface(s) 45, a communication interface 50, a plurality of sensors 56, and a multi-touch display panel 58. In another implementation, the computing device 15 may be a personal computer, an all in one computing device, a gaming console, a server, a visual player, an electronic notepad, a plurality of distributed computing devices, or any other suitable computing device that includes a processor, a plurality of sensors and a multi-touch display. In the implementation where the computing device 15 is not a portable device, a plurality of sensors (e.g., inertial sensors) may be attached to the hands of the user of the system 5.

In other examples, the computing device 15 may include additional components and some of the components depicted therein may be removed and/or modified without departing from a scope of the system that allows for carrying out the functionality described herein. It is to be understood that the operations described as being performed by the processor 30 of the computing device 15 that are related to this description may, in some implementations, be performed by a processor in the 3D display 10, an external processor (not shown), or distributed between the computing device 15 and other electronic/computing devices (not shown).

As explained in additional details below, the computing device 15 may include software, hardware, or a suitable combination thereof configured to enable functionality of the computing device 15 and to allow it to carry out the techniques described below and to interact with the one or more systems or devices. The computing device 15 may include communication interfaces (e.g., a Wi-Fi® interface, a Bluetooth® interface, a 3G interface, a 4G interface, a near field communication (NFC) interface, etc.) that are used to connect with other devices/systems and/or to a network (not shown). The network may include any suitable type or configuration of network to allow for communication between the computing device 15, the 3D display 10, and any other devices/systems (e.g., other computing devices, displays, etc.).

The processor 30 of the computing device 15 (e.g., a central processing unit, a group of distributed processors, a microprocessor, a microcontroller, an application-specific integrated circuit (ASIC), a graphics processor, a multiprocessor, a virtual processor, a cloud processing system, or another suitable controller or programmable device), the memory 35, the engines 39-42, the input interfaces 45, the communication interface 50, the plurality of sensors 56, and the multi-touch display panel 58 may be operatively coupled to a bus 55. The processor 30 may be suitable to retrieve and execute instructions stored in machine-readable storage medium 37. Processor 30 can include single or multiple cores on a chip, multiple cores across multiple chips, multiple cores across multiple devices, or combinations thereof. The processor 30 may be implemented using any suitable type of processing system where at least one processor executes computer-readable instructions stored in the memory 35.

The communication interface 50 may allow the computing device 15 to communicate with plurality of networks, communication links, and external devices. The input interfaces 45 may receive information from devices/systems in communication with the computing device 15. In one example, the input interfaces 45 include at least a data interface 60 that may receive data from any external device or system.

The memory 35 may include any suitable type, number, and configuration of volatile or non-transitory machine-readable storage media 37 to store instructions and data. Examples of machine-readable storage media 37 in the memory 35 include read-only memory (“ROM”), random access memory (“RAM”) (e.g., dynamic RAM [“DRAM”], synchronous DRAM [“SDRAM”], etc.), electrically erasable programmable read-only memory (“EEPROM”), magnetoresistive random access memory (MRAM), memristor, flash memory, SD card, floppy disk, compact disc read only memory (CD-ROM), digital video disc read only memory (DVD-ROM), and other suitable magnetic, optical, physical, or electronic memory on which software may be stored. The memory 35 may include a gesture library (not shown) and may also be used for storing temporary variables or other intermediate information during execution of instructions to by the processor 30.

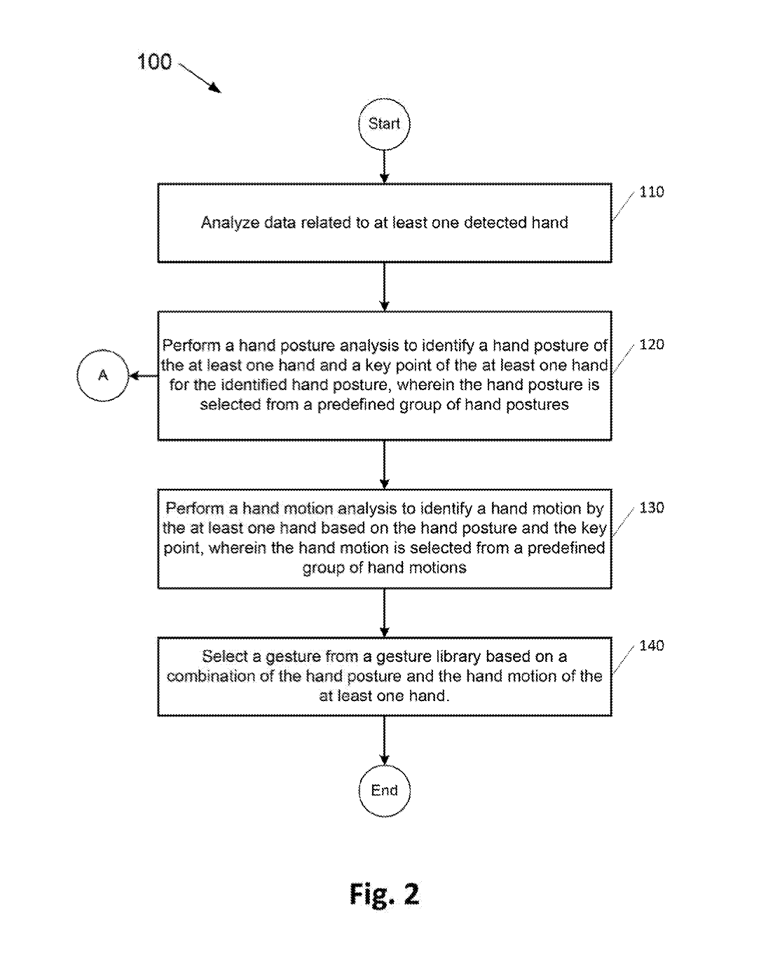

The computing device 15 may include various engines 39-42. Each of the engines 39-42 may include, for example, at least one hardware device including electronic circuitry for implementing the functionality described below, such as control logic and/or memory. In addition or as an alternative, the engines 39-42 may be implemented as any combination of hardware and software to implement the functionalities of the engines. For example, the hardware may be a processor and the software may be a series of instructions or microcode encoded on a machine-readable storage medium and executable by the processor. Therefore, as used herein, an engine may include program code, e.g., computer executable instructions, hardware, firmware, and/or logic, or combination thereof to perform particular actions, tasks, and functions described in more detail herein in reference to FIGS. 2-7.

The data processing engine 39 may process data related to at least one detected hand of a user. In some examples, the data may be received from the plurality of sensors 56 and other elements of the system 5. The data processing engine 39 may use various techniques to process the data related to the hand(s) of the user.

In one implementation, the hand posture engine 40 may perform hand posture recognition of a user by using data from the data processing engine 39. For instance, the hand posture engine 40 may receive data and may determine a hand posture of the at least one hand of a user and a key point of the at least one hand for the identified hand posture. In one example, the hand posture is selected from a predefined group of hand postures that includes: a two hand hold posture, a pinch posture, a point posture, a grab posture, and a slice posture. As explained in additional details below, the hand posture engine 40 may determine whether one or two user hands are detected, may analyze the data related to the detected hands, and may identify a hand posture form the predefined group of hand postures based on the analysis.

The hand motion engine 41 may perform hand motion recognition of a user by using data from the data processing engine 39. For example, hand motion engine 41 may determine a hand motion by the at least one hand based on the hand posture and the key point for that hand posture. The hand motion may be selected from a predefined group of hand motions that include: a directional movement motion, a tapping motion, a circle motion, a swipe motion, a shake motion, and a throw motion.

The gesture selection engine 42 may identify a gesture from a gesture library based on a combination of the hand posture and the hand motion of the at least one hand. In one example, the engine 42 may select a combination of the hand gesture and the hand motion as a definition of a specific gesture (e.g., point and circle gesture, grab and shake gesture, etc.)

The plurality of sensors 56 may include different types of sensors that define a gestural interaction space (not shown) around the computing device 15. In one example, the sensors may include at least one optical depth sensor (e.g., stereo correlator, structured light, time-of-flight, etc.) positioned on the computing device 15 for scanning or collecting information from an environment around the device 15. The optical depth sensors may assist with recognizing the position of the computing device and identifying of various hand gestures of a user. In some implementations (e.g., when the device 15 is too thin and can't accommodate sensors), the system 5 may include a removable jacket (not shown) attachable to the computing device 15 to include the optical depth sensors. The removable jacket may have any form or size that fits the computing device 15.

In addition, the system 5 may include at least one passive optical sensor (e.g., a camera, etc.) positioned on the computing device 15 for scanning or collecting information from an environment around the device 15. The passive optical sensor may provide visual feedback of a user (e.g., eyes, head detection, hand detection, etc.). The system 5 may also include a plurality of inertial sensors (e.g., accelerometers, gyroscopic sensors, magnetometers, etc.) positioned on the computing device 15 that may recognize movement and position of the computing device and hand position of the user (e.g., by the orientation/angle of the device 15). Other types of sensors may also be used by the system to collect data.

The display panel 58 may be an LCD (Liquid Crystal Display), OLED (organic light emitting display) or another type of display. In one example, the display 58 may be a multi-touch display that can be controlled by the user through simple or multi-touch gestures. The display 58 may include any suitable touch-sensitive display technology that may be used for detecting touches on the touch-sensitive display. In some implementations, the display 58 may include and at least one of a prismatic film (e.g., for glasses free operation) and a polarizing film (for use with passive optical glasses) attached to a top surface of the computing device 15 and covering the multi-touch display. In some examples, the film may be added to a jacket for the computing device 15. Having a prismatic film or a polarizing film on the display 58 may allow a user to view 3D visualizations on the computing device 15 and to move these 3D visualizations to the 3D display 10.

FIG. 2 illustrates a flow chart showing an example of a method 100 for selecting a gesture from a gesture library in accordance with an implementation of the present disclosure. Although execution of the method 100 is described below with reference to the system 5, the components for executing the method 100 may be spread among multiple devices. The method 100 may be implemented in the form of executable instructions stored on a machine-readable storage medium, such as storage medium 37, and/or in the form of electronic circuitry.

In one example, the method 100 can be executed by the processor 30 of the computing device 15. In other examples, the method may be executed by a processor on the 3D display 10, or another processor in communication with the system 5. Various elements or blocks described herein with respect to the method 100 are capable of being executed simultaneously, in parallel, or in an order that differs from the illustrated serial manner of execution. The method 100 is also capable of being executed using additional or fewer elements than are shown in the illustrated examples.

The method 100 begins at 110, where the processor 30 may analyze data related to at least one detected hand of a user of the system 5. In one example, the processor 30 may analyze various data received from the plurality of sensors 56 and the elements of the system 5. The processor may use various techniques to process the data related to the user's hands. (e.g., techniques regarding recognizing hands, palms, fingers, etc. based on data from the different sensors).

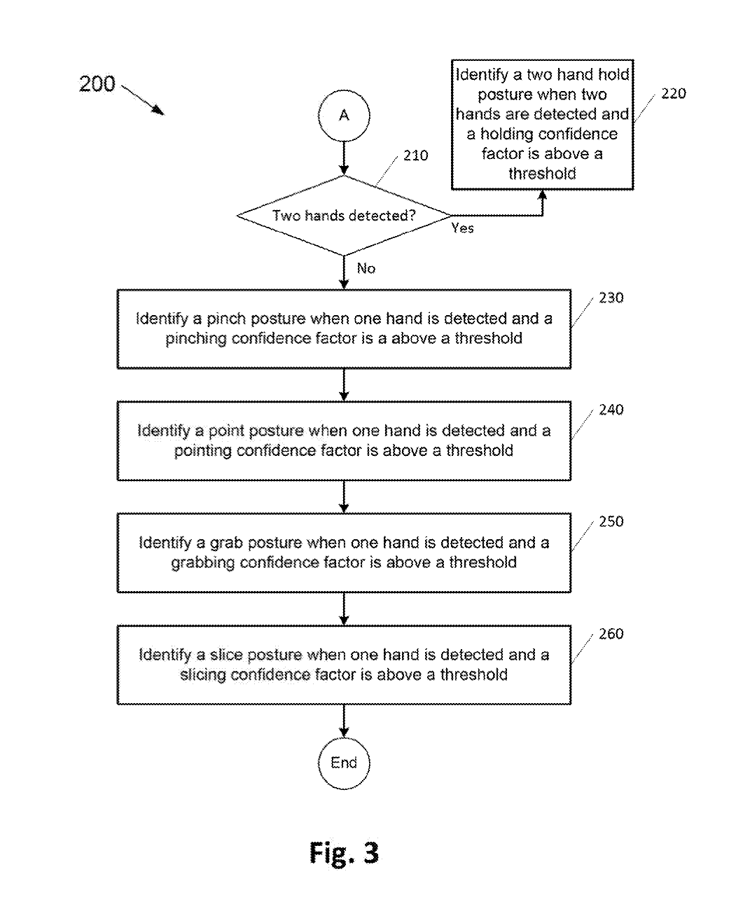

At 120, the processor 30 may perform a hand posture analysis to identify a hand posture of the at least one hand and a key point of the at least one hand for the identified hand posture. As explained in additional details below, the processor may also identify hand posture for both hands of a user. In one example, the hand posture is selected from a predefined group of hand postures that includes a two hand hold posture, a pinch posture, a point posture, a grab posture, and a slice posture. One example of such technique for determining a hand posture is described below in relation to FIG. 3.

Once the processor identifies the hand posture of the at least one user hand, the processor may automatically identify a key point of the at least one hand for the identified hand posture. As mentioned above, the term “key point” refers to an important point of a hand in a specific posture, where that key point is used to in the hand motion analysis. The specific key point of the predefined group of hand postures are described in more detail below.

With continued reference to FIG. 2, the processor 30 may perform a hand motion analysis to identify a hand motion by the at least one hand based on the hand posture and the key point of the at least one hand for the identified hand posture (at 130). In some implementations, the hand motion analysis may include different techniques and algorithms (e.g., hidden Markov models, etc.) for recognizing hand motion from series of optical images. As explained in more details below, the hand motion analysis is performed after the system recognizes the hand posture of the user. Then, the system uses the identified hand posture and the corresponding key point to optimize the results of the hand motion analysis. In one example, the hand motion is selected from a predefined group of hand motions. The predefined group of hand motions may include a directional movement motion, a tapping motion, a circle motion, a swipe motion, a shake motion, and a throw motion.

At 140, the processor 30 may select a gesture from a gesture library based on a combination of the hand posture and the hand motion of the at least one hand. In other words, by quickly identifying the posture and the hand motion of the user's hand from the predefined groups of postures and motions, the processor may identify one of predefined combinations of hand gesture and hand motion as a specific gesture (e.g., point and circle gesture, grab and shake gesture, etc.).

FIG. 3 illustrates a flow chart showing an example of a method 200 for identifying a hand posture. In one example, the method 200 can be executed by the processor 30 of the computing device 15. Alternatively, the components for executing the method 200 may be spread among multiple devices.

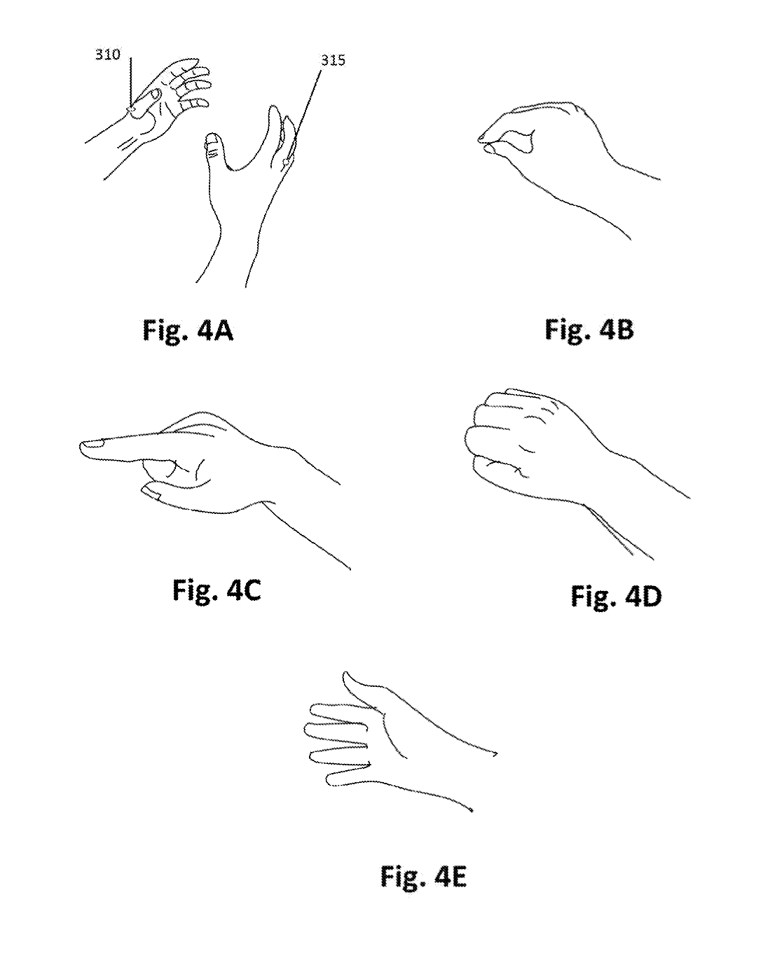

The method 200 may be executed in iteration, where each iteration may include the techniques described below. The general idea of the described method is to recognize the most obvious choice of a hand posture from a predefined group first before trying to recognize the less obvious choices. For instance, it is very easy to find two hands showing in a frame, but harder to distinguish a slice hand posture to a regular hand posture. FIGS. 4A-4E illustrate an example of a predefined group of hand postures in accordance with an example implementation of the present disclosure.

In the described method, the system may pass through recognition procedures for a predefined group of hand postures one by one, and may return confidence factors of each recognized posture. As used herein, the term “confidence factor” refers to a component used to indicate the confidence level of an identified posture. In some implementations, the confidence factors of the different hand posture may be set between zero and one, where zero may represent no confidence of the recognized posture and one may represent an absolute confidence of the recognized posture.

In one example, thresholds related to the confidence factors for the different hand posture may be set in order to filter the different hand postures. For instance, if a threshold for pinch gesture confidence factors is set at a specific value and the returned confidence factor value passes the threshold, the system may not compute the pointing, grabbing, and slicing gestures confidence factors for the same hand posture.

The method 200 begins at 210, where the processor 30 may determine whether one or two hands of the user are detected. In one implementation, the processor may apply different detection techniques based on various data received from the sensors 56 and the other elements of the system 5 to determine the number of hands. Based on the number of detected hands the processor may further identify the posture of the hand(s).

In one implementation, the processor 30 may identify a two hand hold posture when two hands are detected (at 210) and a holding confidence factor is above a threshold (at 220). The two hand hold posture may represent a pose where the two hands of a user are facing one another with the natural hand posture. An example hand hold posture is show in FIG. 4A.

The holding confidence factor related to a two hand hold posture may be calculated by using the following equation:

$${F}_{hold} = ( {N}_{m} - \vert {N}_{1} + {N}_{2} \vert ) / {N}_{m} \times max ( ( 1 - \frac{\vert {A}_{1} - {A}_{t} \vert}{{A}_{m}} ) , 0 ) \times max ( ( 1 - \frac{\vert {A}_{2} - {A}_{t} \vert}{{A}_{m}} ) , 0 ) \qquad Equation 1$$

In this equation, F_{hold} is the holding confidence factor for the two hand hold posture; N₁ is a normal vector of the first hand 310, where the normal vector for a hand is defined as the vector perpendicular to the tangent plane to the palm at the key point and pointing away from the back of the hand; N₂ is a normal vector of the second hand 320; Nm is the maximum magnitude allowed for the vector addition N₁ and N₂; A₁ is the angle between a vector of the two palm centers of the hands 310-315 and N₁; A₂ is the angle between the vector of the two palm centers of the hands 310-315 and N₂; Aₜ is the threshold angle between the vector of the two palm centers of the hands 310-315 and a normal vector of one of the hands (e.g., left or right hand); and Aₘ is the maximum angle allowed between the vector of two palm centers of the hands 310-315 and its palm normal.

Therefore, when the processor determines that two hands are used and that the holding confidence factor is above a predefined threshold (which may be have different levels and may be changed by a user), the processor may identify a two hand hold posture. At that point, the processor may stop the hand posture analysis.

In another example, the processor 30 may identify a pinch posture when one hand is detected (at 210) and a pinching confidence factor is above a threshold (at 230). The pinch posture may represent a pose where a thumb, an index, and/or middle finders of a hand are touching together with each other simultaneously. An example hand pinch posture is show in FIG. 4B.

The pinching confidence factor related to a pinch posture may be calculated by using the following equations:

$${F}_{1} = 1 - \frac{distance ( {P}_{t} , {P}_{i} )}{{D}_{max}} \\ {F}_{2} = 1 - \frac{distance ( {P}_{t} , {P}_{m} )}{{D}_{max}} \\ {F}_{pinch} = max ( {F}_{1} , {F}_{2} , 0 ) \qquad Equation 2$$

In these equations, F_{pinch} is the pinching confidence factor for the pinch posture; Pₜ is the position of the thumb fingertip; Pᵢ is the position of the index fingertip; Pₘ is the position of the middle fingertip; and Dₘₐₓ is the maximum distance allowed between figures for pinch gesture. Therefore, when the processor determines that one hand is used and that the pinching confidence factor is above a predefined threshold, the processor may identify a pinch posture. At that point, the processor may stop the hand posture analysis and may not proceed with the analysis of the other possible one hand postures.

The processor 30 may also identify a point posture when one hand is detected (at 210) and a pointing confidence factor is above a threshold (at 240). The point posture may represent a pose where an index finger of a hand is in a pointing state without touching the palm of the hand or other fingers at the tip. An example hand point posture is show in FIG. 4C.

The pointing confidence factor related to a point posture may be calculated by using the following equation:

$${F}_{point} = min ( \frac{angle ( {V}_{i} , {V}_{m} + {V}_{r} + {V}_{p} )}{{A}_{min}} , 1 ) \qquad Equation 3$$

In this equation, Fₚₒᵢₙₜ is the pointing confidence factor for the point posture; Vᵢ is a vector of the index finger; Vₘ is a vector of the middle finger; Vᵣ is a vector of the ring finger; Vₚ is a vector of the pinky finger and Aₘᵢₙ is the minimum angle allowed between the index finger and the addition of the middle, the ring, and the pinky finger vectors. Therefore, when the processor determines that one hand is used and that the pointing confidence factor is above a predefined threshold, the processor may identify a point posture. At that point, the processor may stop the hand posture analysis and may not proceed with the analysis of the other possible one hand postures.

The processor 30 may further identify grab posture when one hand is detected (at 210) and a grabbing confidence factor is above a threshold (at 250). The grab posture may represent a pose where all fingers are in a first state and are touching the palm of the hand or other fingers. An example hand grab posture is shown in FIG. 4D.

The grabbing factor related to a grab posture may be calculated by using the following equation:

$${F}_{grab} = min ( \frac{angle ( {V}_{i} + {V}_{m} + {V}_{r} + {V}_{p} , {V}_{dir} )}{{A}_{min}} , 1 ) \qquad Equation 4$$

In this equation, F_{grab} is the grabbing confidence factor for the grab posture; Vᵢ is a vector of the index finger; Vₘ is a vector of the middle finger; Vᵣ is a vector of the ring finger; Vₚ is a vector of the pinky finger; V_{dir} is a vector of the palm direction (e.g., from the wrist to the palm center); and Aₘᵢₙ is the minimum angle allowed between the index finger and the addition of the middle, the ring, and the pinky finger vectors. Therefore, when the processor determines that one hand is used and that the grabbing confidence factor is above a predefined threshold, the processor may identify a grab posture. At that point, the processor may stop the hand posture analysis and may not proceed with the analysis of the other possible one hand postures.

The processor 30 may further identify slice posture when one hand is detected (at 210) and a slicing confidence factor is above a threshold (at 260). The slice posture may represent a pose where all fingers are not touching each other and the palm direction is aligned with a predefined axis or direction for slicing. An example hand point posture is show in FIG. 4E.

The slicing factor related to a slice posture may be calculated by using the following equations:

$${F}_{fingers} = min ( \frac{angle ( {V}_{i} + {V}_{m} + {V}_{r} + {V}_{p} , {V}_{dir} )}{{A}_{min}} , 1 ) \\ {F}_{normal} = min ( \frac{angle ( {V}_{n} , {V}_{axis} )}{{A}_{min}} , 1 ) \\ {F}_{slice} = average ( {F}_{fingers} , {F}_{normal} ) \qquad Equation 5$$

In these equations, F_{slice} is the slicing confidence factor for the slice posture, which may be derived from an average of the confidence factors for the normal associated with the fingers (F_{fingers}) and the normal associated with the palm (Fₙₒᵣₘₐₗ); Vᵢ is a vector of the index finger; Vₘ is a vector of the middle finger, Vᵣ is a vector of the ring finger Vₚ is a vector of the pinky finger; V_{dir} is a desired slicing direction vector; Vₙ is the normal vector of the palm; Vₐₓᵢₛ is the desired slicing axis vector and Aₘᵢₙ is the minimum angle allowed between the addition of the index, the middle, the ring, and the pinky finger vectors and the slicing direction vector V_{dir}. Therefore, when the processor determines that one hand is used and that the slicing confidence factor is above a predefined threshold, the processor may identify a grab posture.

Identifying a hand posture of the user may also include identifying a corresponding key point of the at least one hand for the particular hand posture. For example, when the processor identifies the hand posture of the at least one user hand, the processor may automatically determine a key point of the at least one hand for the identified hand posture based on the available sensor data.

In one implementation, the key points corresponding to the predefined group of hand postures described above may include: a) a center point between the palm centers of the two hands of the user for the two hand hold posture; b) a center point between the centers of selected two finger tips defining a pinch for the pinch posture; c) a fingertip position of the index finger for the point posture; d) a first palm center position of a detected hand for the grab posture; and e) a second palm center position of a detected hand for the slice posture. Different techniques may be used to compute the key points of the identified hand postures. In one example, the first palm center position for the grab posture may be determined by using a 3D model of the user's hand, where the system can detect the position of all fingers (e.g., all bent inward, etc.). Based on that information, the processor may determine the location of the palm center when it identifies that the user's hand is in a grab posture.

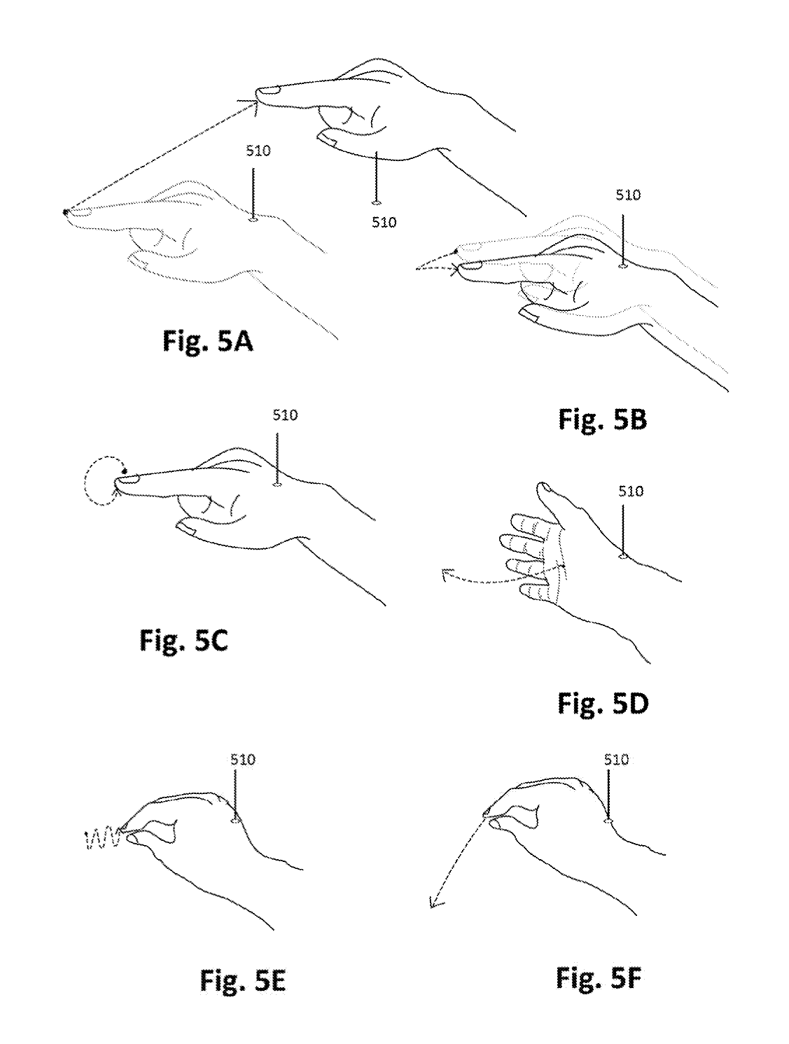

As mentioned in block 130 of the method 100, after the processor 30 identifies a hand posture the processor may perform a hand motion analysis or recognition to determine a hand motion by the at least one hand based on the identified hand posture and the key point for the hand posture. Thus, the system may use the identified hand posture and the corresponding key point to optimize the results of the hand motion analysis. In one example, the hand motion may be selected from a predefined group of hand motions. FIGS. 5A-5F illustrate an example of a predefined group of hand motions in accordance with an example implementation of the present disclosure. The predefined group of hand motions may include a directional movement motion, a tapping motion, a circle motion, a swipe motion, a shake motion, and a throw motion.

FIG. 5A shows a directional movement motion, where a hand 510 of a user defines a first hand posture (e.g., point posture) and then gradually moves to another location with slow or moderate speed with or without change the existing posture. FIG. 58 shows a tapping motion, where a hand 510 of the user defines a posture (e.g., point posture) and then the hand quickly moves forward toward the user's finger pointing direction and backward in the opposite direction.

FIG. 5C shows a circle motion, where a hand 510 of the user defines a posture (e.g., point posture) and then the hand (e.g., one of the fingers) draws a circle in the air in wither clockwise or counterclockwise direction. FIG. 5D shows a swipe motion, where a hand 510 of the user defines a posture (e.g., slice posture) and then the hand gradually accelerates its hand movement speed toward the hand's palm normal direction or in the opposite direction.

FIG. 5E shows a shake motion, where a hand 510 of the user defines a posture (e.g., pinch posture) while making small movements up and down. FIG. 5F shows a throw motion, where a hand 510 of the user defines a posture (e.g., pinch posture) and then moves very fast toward any direction (e.g., to “throw” a 3D object on the computing device 15).

Thus, the processor may use the key point of the identified hand posture to identify the type of hand motion of the user. In some implementations, the hand motion analysis may include different techniques and algorithms (e.g., hidden Markov models, etc.) for recognizing a hand motion from the received sensor data and the optical images.

In one example, the processor may use cached hand and posture information to better identify a hand motion related to a posture. For instance, the processor may store an initial posture/position of the user's hand(s) (including location of the key point) in the cache and may compare that initial posture with after motion posture (which may or may not be the same as the initial posture) to determine the hand motion of the user by analyzing the movement of the user's hand(s). The processor may compare the key point of the initial posture with the key point of the after motion posture to identify the hand motion of the user. For example, the processor may subtract the distance between the two key points to determine a vector that, along with the hand posture, is used to determine the hand motion. The processor may store the posture(s)/position(s) of the user's hand(s) (including location of the key point) before, during, and after the hand motion.

As noted in block 140 of the method 100, after the processor 30 identifies a hand posture and a hand motion of the user's hand(s) the processor may select a gesture from a gesture library based on a combination of the hand posture and the hand motion of the at least one hand. Thus, the proposed system offers a systematic library of predefined hand posture and motion compositions. Having a low number of predefined hand postures and hand motions that define the library of gestures allows the processor to quickly identify the posture/motion combination (e.g., point and rotate, point and swipe, etc.).

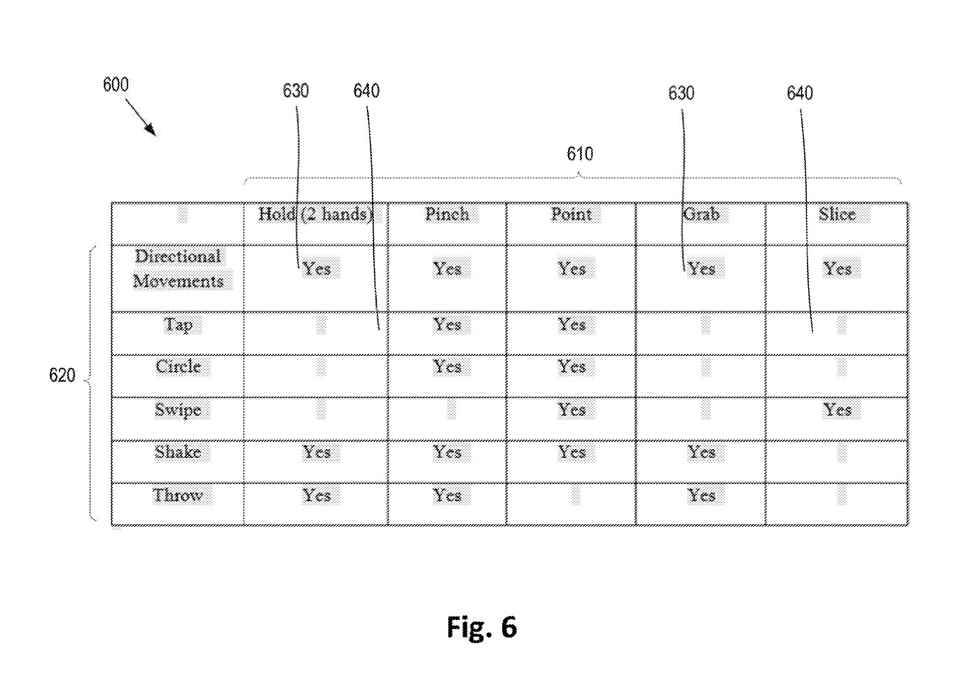

FIG. 6 illustrates an example of a gesture library 600 showing possible hand posture and hand motion combinations in accordance with an example implementation of the present disclosure. In one implementation, the library 600 may be represented as a table that may be stored in the memory 35 of the device 15 or may be stored on any other device.

The table 600 may include a predefined group of hand postures 610 and a predefined group of hand motions 620 that may define different gesture combinations 630. Useful gestures 630 (i.e., posture/motion combinations) may be identified with “Yes” on the table 600 and the empty posture/motion combinations 640 may not be identified as gestures by the system. Thus, a processor may identify different combinations of hand postures/motions based on user's manipulation of digital content.

The library 600 illustrates one example of selecting or identifying a gesture based on a combination of the hand posture and the hand motion. In one implementation, the processor 30 may use a table to identify or implement a gesture that is triggered when a posture/movement combination is detected from a 2D gesture table with functional references to interaction methods. For instance, the table may include a 2D array, with rows and columns representing postures and motion, where the intersection of the posture/motion may be used to save a reference to a function that initiates the respective interaction effect (e.g., like a pointer to the interaction function).

Therefore, by quickly identifying the posture and the hand motion of the user's hand from the predefined groups of postures and motions, the processor 30 may identify one of predefined combinations of hand posture and hand motion as a specific gesture (e.g., point and circle gesture, grab and shake gesture, etc.).

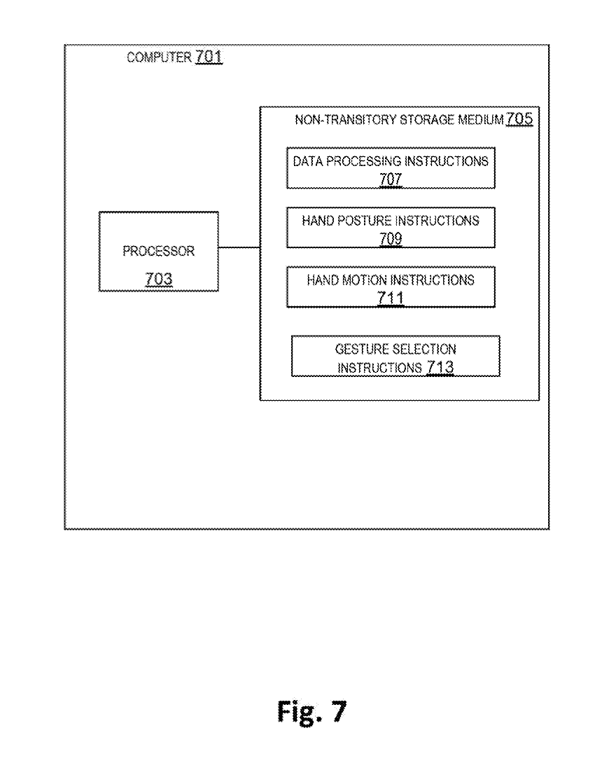

FIG. 7 illustrates a computer 701 and a non-transitory machine-readable medium 705 according to an example. In one example, the computer 701 maybe similar to the computing device 15 of the system 5 or may include a plurality of computers. For example, the computers may be server computers, workstation computers, desktop computers, laptops, mobile devices, or the like, and may be part of a distributed system. The computers may include one or more controllers and one or more machine-readable storage media. In one example, the computer may include a user interface (e.g., touch interface, mouse, keyboard, gesture input device, etc.).

Computer 701 may perform methods 100-200 and variations thereof. Additionally, the functionality implemented by computer 701 may be part of a larger software platform, system, application, or the like. Computer 701 may be connected to a database (not shown) via a network. The network may be any type of communications network, including, but not limited to, wire-based networks (e.g., cable), wireless networks (e.g., cellular, satellite), cellular telecommunications network(s), and IP-based telecommunications network(s) (e.g., Voice over Internet Protocol networks). The network may also include traditional landline or a public switched telephone network (PSTN), or combinations of the foregoing.

The computer 701 may include a processor 703 and non-transitory machine-readable storage medium 705. The processor 703 may be similar to the processor 30 of the computing device 15 and non-transitory machine-readable storage media 705 may be similar to the machine-readable storage media 37 of the device 15. Software stored on the non-transitory machine-readable storage media 705 and executed by the processor 703 includes, for example, firmware, applications, program data, filters, rules, program modules, and other executable instructions. The processor 703 retrieves from the machine-readable storage media 705 and executes, among other things, instructions related to the control processes and methods described herein.

The processor 703 may fetch, decode, and execute instructions 707-713 among others, to implement various processing. As an alternative or in addition to retrieving and executing instructions, processor 703 may include at least one integrated circuit (IC), other control logic, other electronic circuits, or combinations thereof that include a number of electronic components for performing the functionality of instructions 707-713. Accordingly, processor 703 may be implemented across multiple processing units and instructions 707-713 may be implemented by different processing units in different areas of computer 701.

The instructions 707-713 when executed by processor 703 (e.g., via one processing element or multiple processing elements of the processor) can cause processor 703 to perform processes, for example, methods 100-200, and/or variations and portions thereof. In other examples, the execution of these and other methods may be distributed between the processor 703 and other processors in communication with the processors 703.

For example, data processing instructions 707 may cause processor 703 to analyze information related to at least one detected hand of a user. These instructions may function similarly to the techniques described in in block 110 of method 100. For example, data processing instructions 707 may cause processor 703 to use different techniques to recognize user's hands, palms, fingers, etc. based on the received data.

Hand posture instructions 709 may cause the processor 703 to perform a hand posture recognition to identify a hand posture of the at least one hand and a key point of the at least one hand for the identified hand posture. These instructions may function similarly to the techniques described in block 120 of method 100 and the method 200. For example, based on the analyzed data, the hand posture instructions 709 may cause the processor 703 to select a hand posture from a predefined group of hand postures (described above).

Hand motion instructions 711 may cause the processor 703 to perform a hand motion recognition to identify a hand motion by the at least one hand based on the hand posture and the key point. These instructions may function similarly to the techniques described in block 130 of method 100 and in the subsequent paragraph related to block 130. In one example, the processor 703 may select a hand motion from a predefined group of hand motions (described above).

Gesture selection instructions 713 may cause the processor 703 to select a combination of the hand posture and the hand motion from a library of predefined combinations. These instructions may function similarly to the techniques described in block 140 of method 100 and in the subsequent paragraph related to block 130 and FIG. 6.

In the foregoing description, numerous details are set forth to provide an understanding of the subject matter disclosed herein. However, implementations may be practiced without some or all of these details. Other implementations may include modifications and variations from the details discussed above. It is intended that the appended claims cover such modifications and variations.

What is claimed is:

1. A method comprising, by at least one processor:
analyzing data related to at least one detected hand;
performing a hand posture analysis to identify a hand posture of the at least one hand and a key point of the at least one hand for the identified hand posture, wherein the hand posture is selected from a predefined group of hand postures;
performing a hand motion analysis to identify a hand motion by the at least one hand based on the hand posture and the key point, wherein the hand motion is selected from a predefined group of hand motions; and
selecting a gesture from a gesture library based on a combination of the hand posture and the hand motion of the at least one hand.

2. The method of claim 1, wherein the predefined group of hand postures includes: a two hand hold posture, a pinch posture, a point posture, a grab posture, and a slice posture.

3. The method of claim 1, wherein the predefined group of hand motions includes: a directional movement motion, a tapping motion, a circle motion, a swipe motion, a shake motion, and a throw motion.

4. The method of claim 2, further comprising:
performing iterations, each iteration comprising:
determining whether one or two hands are detected;
identifying a two hand hold posture when two hands are detected and a holding confidence factor is above a threshold;
identifying a pinch posture when one hand is detected and a pinching confidence factor is above a threshold;
identifying a point posture when one hand is detected and a pointing confidence factor is above a threshold;
identifying a grab posture when one hand is detected and a grabbing confidence factor is above a threshold; and
identifying a slice posture when one hand is detected and a slicing confidence factor is above a threshold.

5. The method of claim 2, wherein the key points for the hand postures include:
a center point between palm centers of two hands for the two hand hold posture;
a center point between centers of selected two finger tips defining a pinch for the pinch posture;
a fingertip position of an index finger for the point posture;
a first palm center position of a detected hand for the grab posture; and
a second palm center position of a detected hand for the slice posture.

6. A system comprising:
a computing device including a touch display and a plurality of sensors;
a data processing engine to process data related to at least one detected hand;
a hand posture engine to perform a hand posture recognition to determine a hand posture of the at least one hand and a key point of the at least one hand for the identified hand posture, wherein the hand posture is selected from a predefined group of hand postures
a hand motion engine to perform a hand motion recognition to determine a hand motion by the at least one hand based on the hand posture and the key point, wherein the hand motion is selected from a predefined group of hand motions; and
a gesture selection engine to identify a gesture from a gesture library based on a combination of the hand posture and the hand motion of the at least one hand.

7. The system of claim 6, wherein the predefined group of hand postures includes: a two hand hold posture, a pinch posture, a point posture, a grab posture, and a slice posture.

8. The system of claim 6, wherein the predefined group of hand motions includes: a directional movement motion, a tapping motion, a circle motion, a swipe motion, a shake motion, and a throw motion.

9. The system of claim 7, wherein the hand posture engine is further to:
determine whether one or two hands are detected;
determine a two hand hold posture when two hands are detected and a holding confidence factor is above a threshold;
determine a pinch posture when one hand is detected and a pinching confidence factor is above a threshold;
determine a point posture when one hand is detected and a pointing confidence factor is above a threshold;
determine a grab posture when one hand is detected and a grabbing confidence factor is above a threshold; and
determine a slice posture when one hand is detected and a slicing confidence factor is above a threshold.

10. The system of claim 7, wherein the key points for the hand postures include:
a center point between palm centers of two hands for the two hand hold posture;
a center point between centers of selected two finger tips defining a pinch for the pinch posture;
a fingertip position of an index finger for the point posture;
a first palm center position of a detected hand for the grab posture; and
a second palm center position of a detected hand for the slice posture.

11. A non-transitory machine-readable storage medium encoded with instructions executable by at least one processor, the machine-readable storage medium comprising instructions to:
analyze information related to at least one detected hand;
perform a hand posture recognition to identify a hand posture of the at least one hand and a key point of the at least one hand for the identified hand posture, wherein the hand posture is selected from a predefined group of hand postures;
perform a hand motion recognition to identify a hand motion by the at least one hand based on the hand posture and the key point, wherein the hand motion is selected from a predefined group of hand motions; and
select a combination of the hand posture and the hand motion from a library of predefined combinations.

12. The non-transitory machine-readable storage medium of claim 11, wherein the predefined group of hand postures includes: a two hand hold posture, a pinch posture, a point posture, a grab posture, and a slice posture.

13. The non-transitory machine-readable storage medium of claim 11, wherein the predefined group of hand motions includes: a directional movement motion, a tapping motion, a circle motion, a swipe motion, a shake motion, and a throw motion.

14. The non-transitory machine-readable storage medium of claim 12, further comprising instructions to:
perform iterations, each iteration comprising:
determine whether one or two hands are detected;
determine a two hand hold posture when two hands are detected and a holding confidence factor is above a threshold;
determine a pinch posture when one hand is detected and a pinching confidence factor is above a threshold;
determine a point posture when one hand is detected and a pointing confidence factor is above a threshold;
determine a grab posture when one hand is detected and a grabbing confidence factor is above a threshold; and
determine a slice posture when one hand is detected and a slicing confidence factor is above a threshold.

15. The non-transitory machine-readable storage medium of claim 12, wherein the key points for the hand postures include:
a center point between palm centers of two hands for the two hand hold posture;
a center point between centers of selected two finger tips defining a pinch for the pinch posture;
a fingertip position of an index finger for the point posture;
a palm center position of a detected hand for the grab posture; and
a palm center position of a detected hand for the slice posture.
